(19) United States
(12) Patent Application Publication
(10) Pub. No.: US 2007/0237636 A1
(43) Pub. Date: Oct. 11, 2007

(54) Computer cooling fan with display device

(76) Inventor: Sam Hsu, Taichung City (TW)

Correspondence Address: PRO-TECHTOR INTERNATIONAL SERVICES, 20775 NORADA CT., SARATOGA, CA, 95070, US

(21) Appl. No.: 11/402,374

(22) Filed: Apr. 7, 2006

(51) Int. Cl. F03D 11/00

(52) U.S. Cl. 416/5; 362/96; 310/73

(57) ABSTRACT

A cooling fan is mounted in a transparent PC case and includes a first winding assembly; a blade assembly; a cross-shaped display device mounted on the blade assembly; a second power source for supplying an oscillation power; a display device including a second winding assembly, a MCU, a memory unit, two LED displays electrically connected to the MCU, two wireless signal receiving members, and a second rectification unit electrically interconnected the second power source and the displays; a wireless receiving unit interconnected the second power source and the MCU; and a wireless data transmission unit adapted to transmit data including operating temperature, voltage, current, and rotating speed of the rotating shaft f from the MCU to the displays for display through the wireless receiving unit when the cooling fan is operating.

### BACKGROUND OF THE INVENTION

1. Field of Invention

The present invention relates to cooling fans and more particularly to such a cooling fan having a display device mounted in a transparent case of a personal computer (PC).

2. Related Art

Conventionally, an electric fan mounted in a computer case is for cooling purpose only. It is also known that a type of PC having a transparent case is commercially available. Thus, a cooling fan having a display device specifically designed for a transparent case is a product to be developed in order to enable a manufacturer of the art to survive in the competitive market.

### SUMMARY OF THE INVENTION

It is therefore an object of the present invention to provide a cooling fan mounted in a transparent case of a personal computer (PC), comprising a rectangular frame; a first rectification unit mounted in the frame and electrically connected to a first power source for supplying DC; a first winding assembly electrically connected to the first rectification unit; a blade assembly electrically connected to the first power source and comprising a rotating shaft mounted in the first winding assembly, a plurality of blades radially extended from the rotating shaft, and two opposite magnets with the first winding assembly disposed therebetween; a second power source for supplying an oscillation power; a cross-shaped display device mounted on the blade assembly and comprising a second winding assembly, a micro-controller unit (MCU) including a plurality of inputs and a plurality of outputs, a memory unit in data communication with the MCU, two opposite LED (light emitting diode) displays electrically connected to the outputs of the MCU, two opposite wireless signal receiving members, and a second rectification unit electrically interconnected the second power source and the displays; a wireless parameter set unit adapted to set and adjust parameters of the displays as controlled by the MCU when the displays are enabled; a wireless receiving unit interconnected the second power source and the MCU and adapted to receive a wireless control signal from the wireless parameter set unit; a calendar unit interconnected a battery and the MCU and adapted to provide date and time data to the MCU; a clock generator adapted to generate clocks and provide same to the MCU; a temperature sensor adapted to sense ambient temperature and provide sensed temperature data to the MCU; a position unit interconnected the MCU and the displays and adapted to position alphanumeric data on a predetermined position of a screen of the displays as controlled by the MCU when the displays are enabled; and a wireless data transmission unit adapted to transmit data including operating temperature, voltage, current, and rotating speed of the rotating shaft from the MCU to the displays for display through the wireless receiving unit when the cooling fan is operating.

It is another object of the present invention to provide the displays are capable of emitting red, green, and blue (RGB) lights.

In one aspect of the present invention there is further provided a buzzer electrically connected to the display device.

In another aspect of the present invention the wireless receiving unit is adapted to receive an infrared, a blue-tooth, or an RF (radio frequency) signal.

In a further aspect of the present invention the temperature sensor is a thermistor.

The above and other objects, features and advantages of the present invention will become apparent from the following detailed description taken with the accompanying drawings.

### BRIEF DESCRIPTION OF THE DRAWINGS

FIG. 1 is an exploded perspective view of a first preferred embodiment of cooling fan according to the invention to be mounted in a transparent computer case;

FIG. 2 is a perspective view of the assembled cooling fan in FIG. 1;

FIG. 3 is a perspective view of the assembled cooling fan in FIG. 1 viewed from an angle opposite FIG. 2;

FIG. 4 is a top plan view of FIG. 2;

FIG. 5 is a sectional view of FIG. 2;

FIG. 6 is a sectional view of FIG. 2 showing another configuration of the cooling fan;

FIG. 7 is a circuit diagram of some components of the cooling fan;

FIG. 8 is an exploded perspective view of a second preferred embodiment of cooling fan according to the invention to be mounted in a transparent computer case;

FIG. 9 is a sectional view of the assembled cooling fan in FIG. 8;

FIG. 10 schematically depicts a wireless parameter set unit of the cooling fan according to either preferred embodiment of the invention;

FIG. 11 is a block diagram of the display device according to either preferred embodiment of the invention;

FIG. 12 is a circuit diagram of the cooling fan according to either preferred embodiment of the invention; and

FIG. 13 is a circuit diagram of a wireless data transmission unit of the cooling fan.

### DETAILED DESCRIPTION OF THE INVENTION

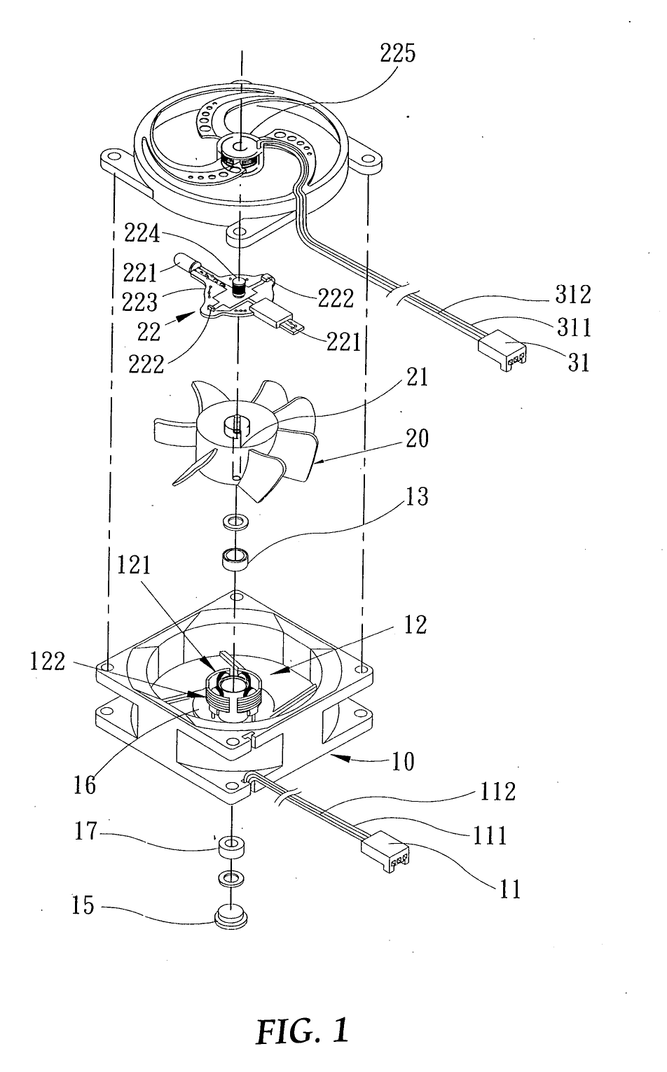

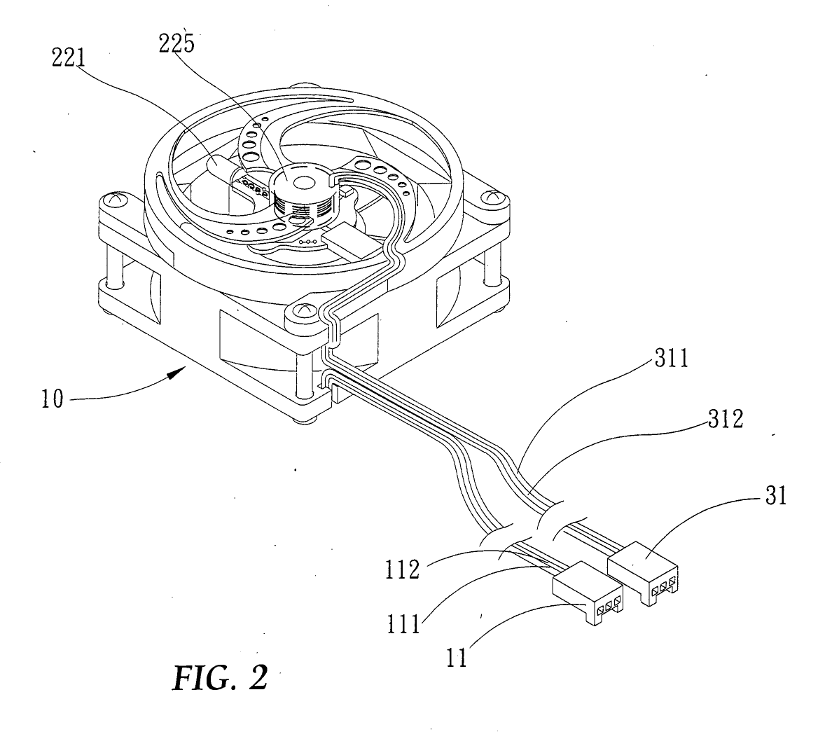

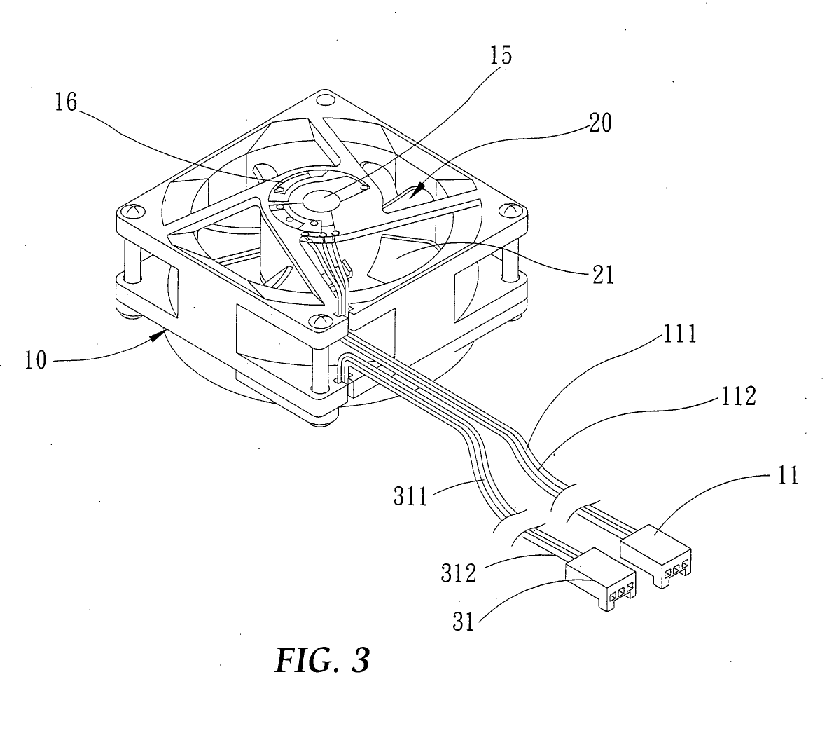

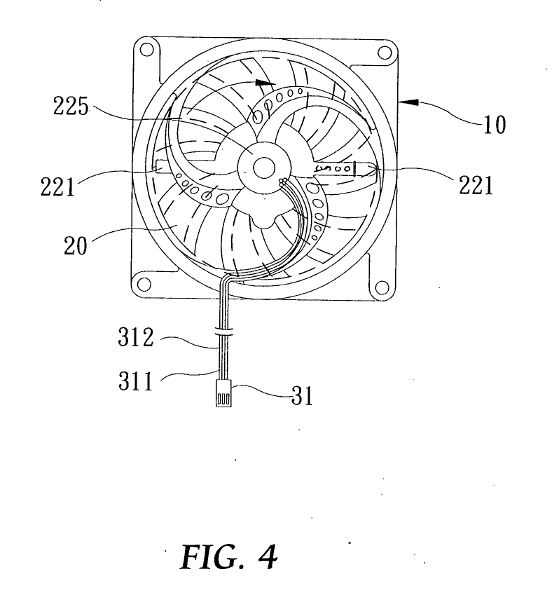

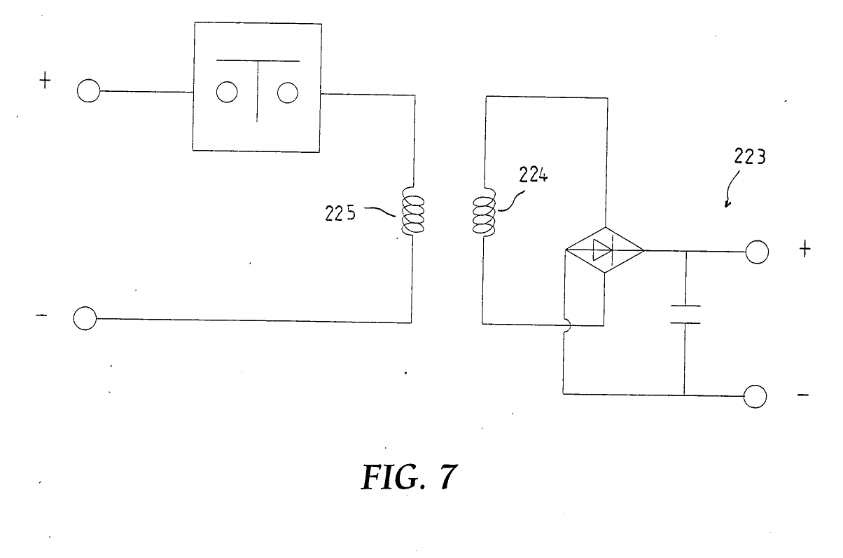

Referring to FIGS. 1 to 13, a cooling fan in accordance with the invention is shown. The cooling fan comprises a frame 10, a blade assembly 20, and a display device 22. Each component is discussed in detailed below.

The rectangular frame 10 comprises a first bearing 13, a second bearing 17 both mounted in its center, a first connection 11 electrically connected to a power source and including a positive wire 111 and a negative wire 112, a dust cap 15, and a first circuit board 16 electrically connected to the power source through the first connection 11 and adapted to rectify and filter so as to supply a stable DC output, a cylindrical winding assembly 12 electrically connected to the first circuit board 16 and including a first winding 121 and a spaced second winding 122.

The blade assembly 20 comprises a hub 21 having a rotating shaft inserted through the bearings 13 and 17, a plurality of blades radially extended from the hub 21, and two opposite magnets 23 with the winding assembly 12 disposed therebetween.

The cross-shaped display device 22 is mounted on a top surface of the blade assembly 20 and includes a third winding 224 and a fourth winding 225. A second connection 31 is electrically interconnected an oscillation-based power source and the display device 22. The second connection 31 comprises a positive wire 311 and a negative wire 312.

The display device 22 further comprises a micro-controller unit (MCU) 220 including a plurality of inputs 220A and a plurality of outputs 20B, a memory unit 220C in data communication with the MCU 220, two opposite display units (e.g., LED (light emitting diode) displays) 221 electrically connected to the outputs 220B of the MCU 220, the display unit 221 being capable of emitting red, green, and blue (RGB) lights, two opposite electronic members 222, and a second circuit board 223.

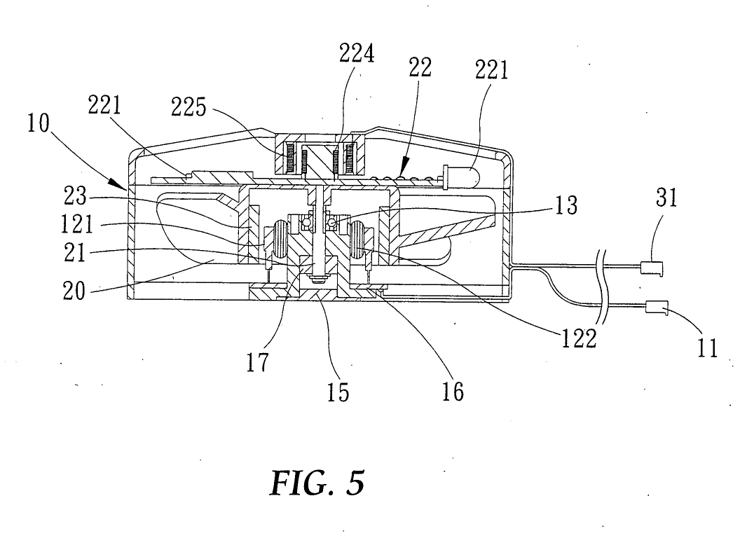

The blades of the blade assembly 20 rotate when DC power is supplied to the first winding 121 and the second winding 122 through the positive wire 111 and the negative wire 112 respectively. In response, the display device 22 rotates, i.e., the third winding 224 rotates in the stationary fourth winding 225 (see FIG. 5).

At the same time, an oscillation power is fed to the fourth winding 225 through the second connection 31. Power is then fed to the second circuit board 223 from the fourth winding 225 through the third winding 224 by inducting. The display units 221 thus flash. Additionally, a buzzer may be provided and is electrically connected to the display device 22 such that the buzzer may make a buzzing sound when the display units 221 are enabled.

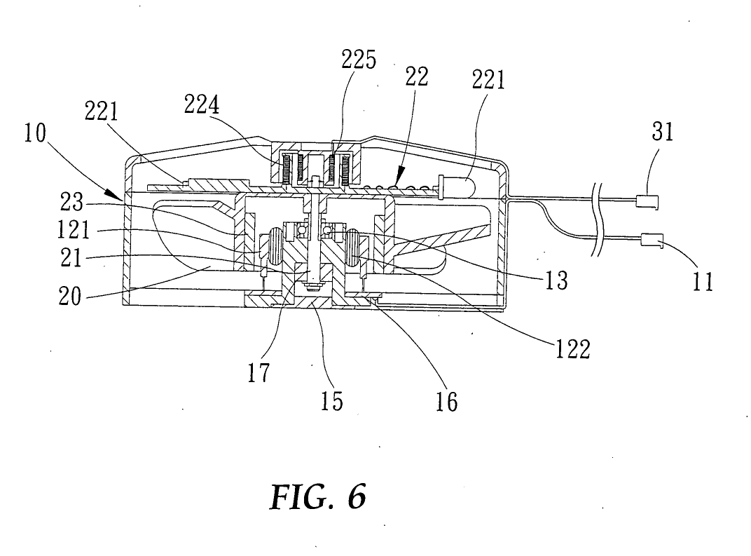

As shown in FIG. 6, the position of the fourth winding 225 is exchanged with that of the third winding 224. That is, the fourth winding 225 rotates in the stationary third winding 224.

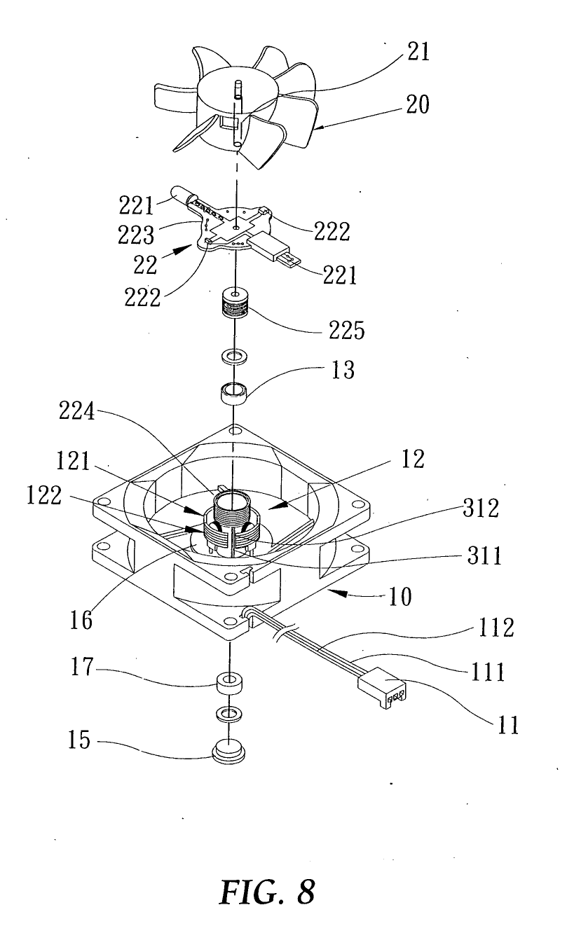

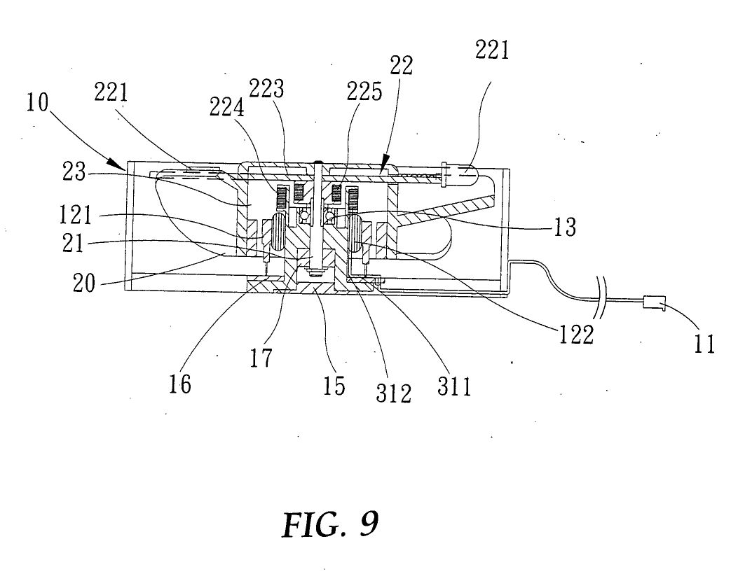

As shown in FIGS. 8 and 9, the third winding 224 is provided in a center of the winding assembly 12. The fourth winding 225 is provided within and is spaced from the third winding 224. Similarly, an oscillation power is fed from the first circuit board 16 to the third winding 224 through the second connection 31. Power is then fed to the display device 22 from the third winding 224 through the fourth winding 225 by inducting.

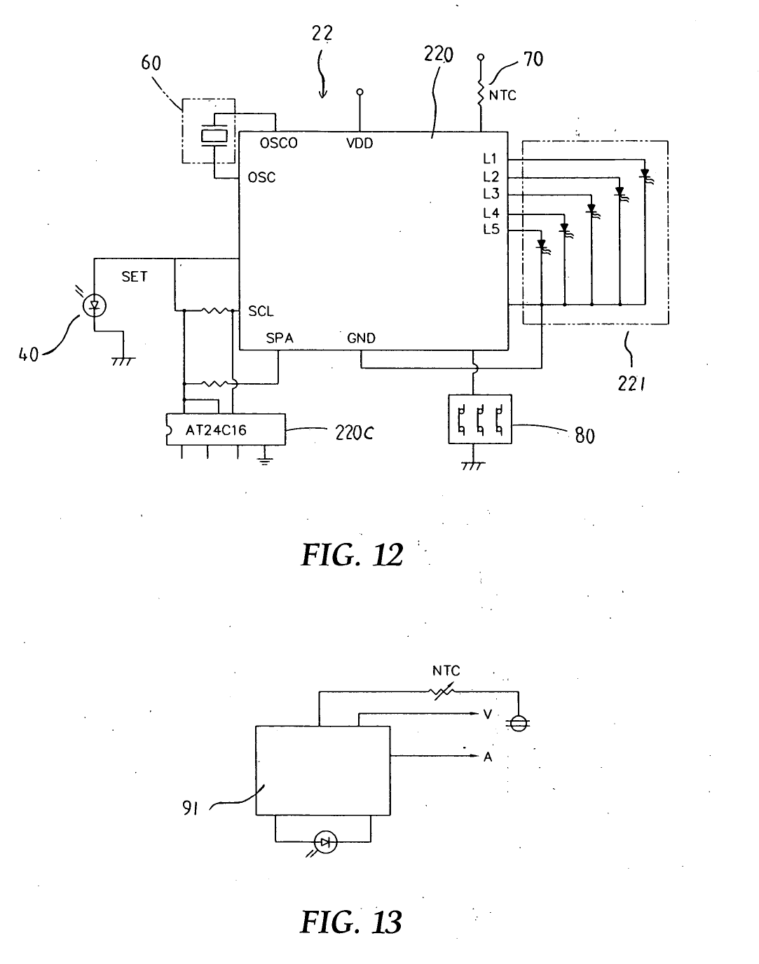

As shown in FIGS. 11 and 12, a wireless receiving unit 40 is interconnected the power source and the first input of the MCU 220, a calendar unit 50 is interconnected a long-life battery and the second input of the MCU 220, a clock generator 60 is connected to the third input of the MCU 220, and a temperature sensor 70 is connected to the fourth input of the MCU 220. Also, a position unit 80 is interconnected the first output 220B of the MCU 220 and the display units 221.

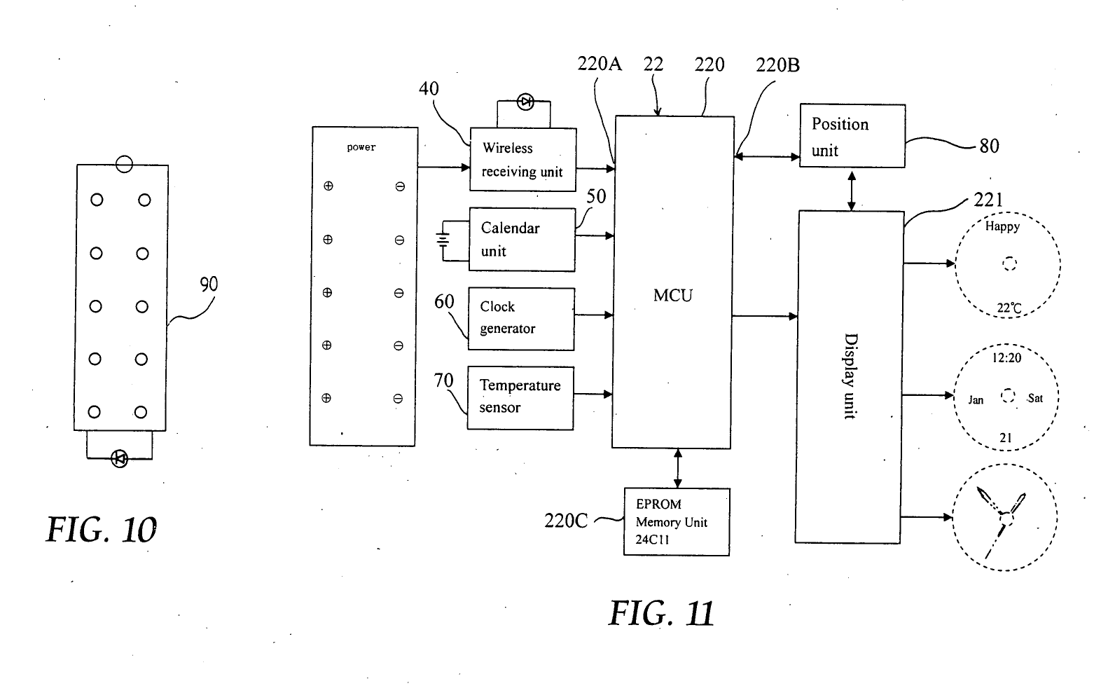

The wireless receiving unit 40 is adapted to receive a wireless control signal (e.g., infrared, blue-tooth, or RF (radio frequency) signal) from a wireless parameter set unit 90 which is implemented as a remote control (see FIG. 10). The wireless parameter set unit 90 is adapted to set and adjust parameters of the display units 221 as controlled by the MCU 220 when the display units 221 are enabled.

The calendar unit 50 is adapted to provide date and time data to the MCU 220. The clock generator 60 is adapted to generate clocks and provide same to the MCU 220. The temperature sensor 70 is adapted to sense ambient temperature and provide temperature data to the MCU 220. The temperature sensor 70 is implemented as a thermistor in the invention. The position unit 80 is adapted to position alphanumeric data on a predetermined position of the screen as controlled by the MCU 220 when the display units 221 are enabled. The position unit 80 is implemented as an optical switch, a reed switch, or a Hall IC.

The electronic members 222 are implemented as wireless signal receiving members. An external wireless data transmission unit 91 is adapted to transmit data including operating temperature, voltage, current, or rotating speed of the cooling fan to the display units 221 for display through the electronic members 222 when the cooling fan is operating.

While the invention herein disclosed has been described by means of specific embodiments, numerous modifications and variations could be made thereto by those skilled in the art without departing from the scope and spirit of the invention set forth in the claims.

What is claimed is:

1. A cooling fan mounted in a transparent case of a personal computer (PC), comprising:
a rectangular frame;
a first rectification unit mounted in the frame and electrically connected to a first power source for supplying DC;
a first winding assembly electrically connected to the first rectification unit;
a blade assembly electrically connected to the first power source and comprising a rotating shaft mounted in the first winding assembly, a plurality of blades radially extended from the rotating shaft, and two opposite magnets with the first winding assembly disposed therebetween;
a second power source for supplying an oscillation power;
a cross-shaped display device mounted on the blade assembly and comprising a second winding assembly, a micro-controller unit (MCU) including a plurality of inputs and a plurality of outputs, a memory unit in data communication with the MCU, two opposite LED (light emitting diode) displays electrically connected to the outputs of the MCU, two opposite wireless signal receiving members, and a second rectification unit electrically interconnected the second power source and the displays;
a wireless parameter set unit adapted to set and adjust parameters of the displays as controlled by the MCU when the displays are enabled;
a wireless receiving unit interconnected the second power source and the MCU and adapted to receive a wireless control signal from the wireless parameter set unit;
a calendar unit interconnected a battery and the MCU and adapted to provide date and time data to the MCU;
a clock generator adapted to generate clocks and provide same to the MCU;
a temperature sensor adapted to sense ambient temperature and provide sensed temperature data to the MCU;
a position unit interconnected the MCU and the displays and adapted to position alphanumeric data on a predetermined position of a screen of the displays as controlled by the MCU when the displays are enabled; and
a wireless data transmission unit adapted to transmit data including operating temperature, voltage, current, and rotating speed of the rotating shaft from the MCU to the displays for display through the wireless receiving unit when the cooling fan is operating.

2. The cooling fan of claim 1, wherein the displays are capable of emitting red, green, and blue (RGB) lights.

3. The cooling fan of claim 1, further comprising a buzzer electrically connected to the display device.

4. The cooling fan of claim 1, wherein the wireless receiving unit is adapted to receive an infrared, a blue-tooth, or an RF (radio frequency) signal.

5. The cooling fan of claim 1, wherein the temperature sensor is a thermistor.
